(19) United States
(12) Patent Application Publication
(10) Pub. No.: US 2016/0128510 A1
(43) Pub. Date: May 12, 2016

(54) GRILL WITH INTEGRATED LIQUID RESERVOIR

(71) Applicant: Le Creuset SAS, Fresnoy-le-Grand (FR)

(72) Inventor: Steve JONES, Charleston, SC (US)

(73) Assignee: Le Creuset SAS, Fresnoy-le-Grand (FR)

(21) Appl. No.: 14/935,218

(22) Filed: Nov. 6, 2015

Related U.S. Application Data
(60) Provisional application No. 62/075,978, filed on Nov. 6, 2014.

(51) Int. Cl. A47J 36/24; A47J 36/02

(52) U.S. Cl. CPC A47J 36/2483; A47J 36/02

(57) ABSTRACT

Disclosed embodiments relate to a grill with an integrated liquid reservoir. The grill includes a Main grill surface, a reservoir and a divider separating the grill surface from the reservoir. The divider has a steeply sloped first side adjacent to the reservoir and a gently sloped second side adjacent to the main grill surface. Certain embodiments of the grill may include a retaining wall surrounding the entire grill. The integrated reservoir may be useful for draining liquids away from foods while cooking or keeping liquids nearby while cooking.

### CROSS REFERENCE TO RELATED APPLICATIONS

This application claims the benefit of U.S. Provisional Application Ser. No. 62/075,978 filed Nov. 6, 2014. Applicant incorporates by reference herein Application Ser. No. 62/075,978 in its entirety.

### FIELD OF THE INVENTION

The invention relates to grills and griddles with integrated liquid reservoirs.

### BACKGROUND AND SUMMARY

Korean BBQ has become widely accepted both inside and outside of Korea as many countries welcome a Korean cultural wave, ‘Hanryu.’ The traditional Korean grills are typically made of cast iron material and are often used in Korean BBQ to grill pork belly. Pork belly BBQ has been ranked among the favorites of the traditional Korean BBQ menu choices such as beef, beef rib BBQ, etc. Therefore there is a need for a I F CREUSET branded cast iron grill with added functionality for Korean pork belly BBQ.

### BRIEF DESCRIPTION OF THE DRAWINGS

FIG. 1 depicts an elevated view of an embodiment of the grill.

FIG. 2 depicts a cut-away side view illustrating a potential embodiment of the liquid reservoir and a smooth grill surface.

FIG. 3 depicts a cut-away side view illustrating a potential embodiment of the liquid reservoir and a textured grill surface and an integrated electric heating element.

FIG. 4 depicts a potential method technique for transferring liquid from the main grill surface to the reservoir by tilting the main grill.

FIG. 5 depicts a potential method technique for transferring liquid from the main grill surface to the reservoir using a tool.

FIGS. 6A-6C depict an embodiment of the grill with three potential lids.

### DETAILED DESCRIPTION

The Korean BBQ grill is a grill 100 with the added functionality of an integrated liquid reservoir 110. In a preferred embodiment, the entire grill 100 is surrounded by a small retaining wall 103. The liquid reservoir 110 is designed with divider separating the main grill surface and the reservoir. The divider has a gentler slope 120 leading from the main grill surface 105 into the reservoir 110 and a significantly steeper slope 130 leading from the reservoir 110 back out to the main grill surface 105. The gentler slope 120 allows liquid from the grill surface 105 to flow easily into the reservoir 110 while the steeper slope 130 prevents liquid from flowing from the reservoir 110 back to the grill surface 105. When cooking pork belly or other foods this will allow for drainage of the excess fat away from the food.

When draining liquid away from the main grill surface 105, the grill 100 may be tilted to allow fluid to flow into the reservoir 110 due to gravity. Alternatively, a tool 140, such as a spatula, may be used to move excess liquid into the reservoir 110.

In addition to draining liquid away from the main grill surface 105, the liquid reservoir 110 may be used to store liquid-like substances such as juices, sauces, marinades, or basting fluid thus eliminating the need for a saucepot. The liquid reservoir 110 allows for easy access to these liquid-like substances at any stage of meal preparation, cooking, serving or presentation.

FIG. 1 shows an overview of a preferred embodiment of the grill 100.

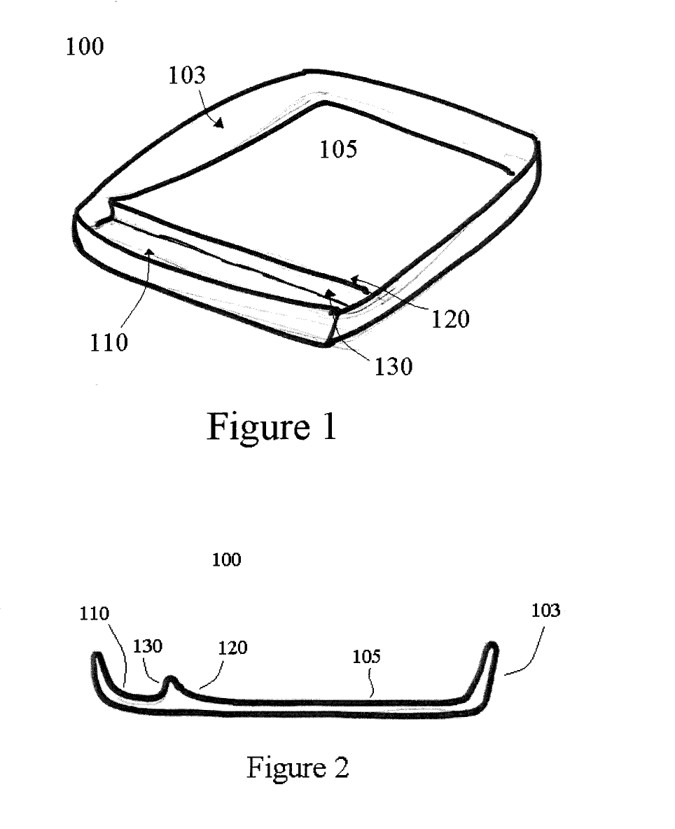

FIG. 2 shows a side view of a cross section of an embodiment with a smooth grill surface 105.

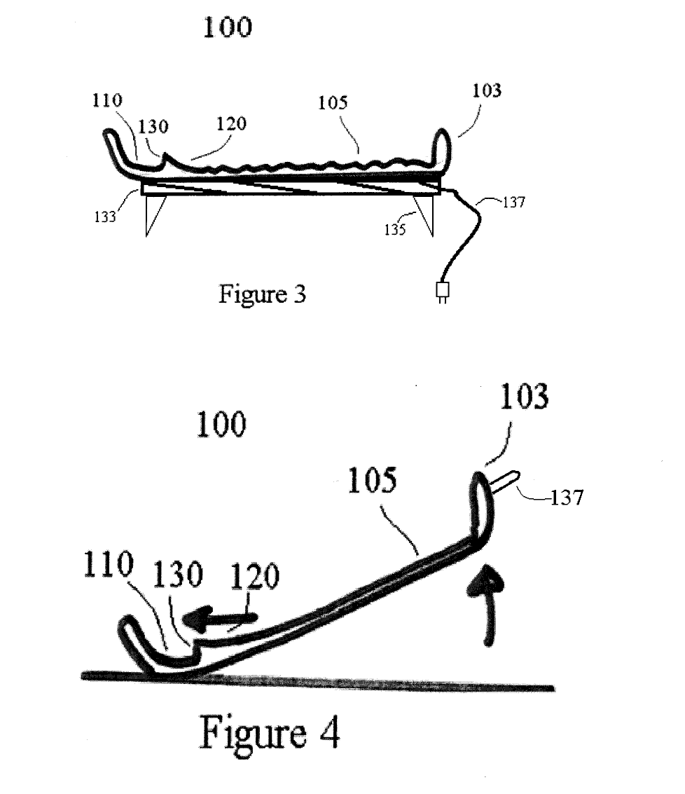

FIG. 3 shows an alternative embodiment with a textured grill surface 105 and an integrated electric heating element 133. This embodiment also includes legs 135 to raise the grill 100 off of the surface the grill 100 is resting on in order to avoid damaging the lower surface with the hot grill 100. This embodiment also includes an electric cord 137 configured to be connected to an electric power supply.

FIG. 4 shows one method of transferring liquid from the main grill surface 105 to the reservoir 110. This method involves tilting the grill 100 such that the main grill surface 105 is elevated with respect to the reservoir 110. The gentle slope 120 allows-liquid to transfer from the grill surface 105 to the reservoir 110 easily.

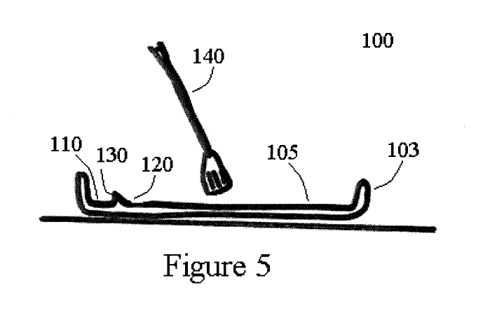

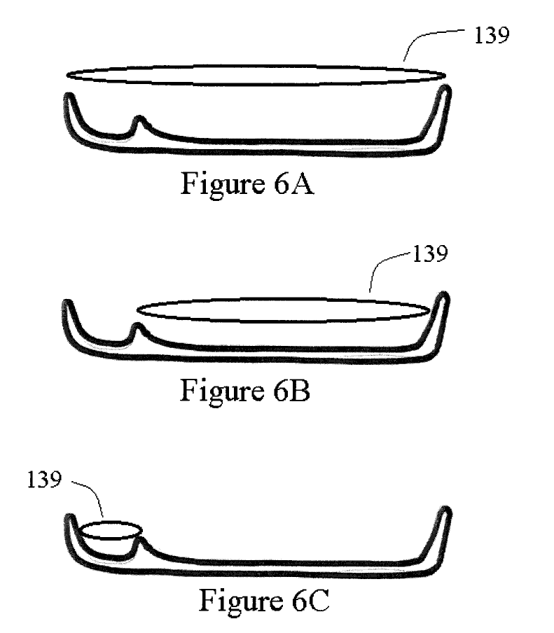

FIG. 5 shows an alternative method of transferring liquid from the grill surface 105 to the reservoir 110. A tool 140, such as a spatula may be used to push liquid over the gently sloped side 120 into the reservoir 110. The steeply sloped side 130 helps to retain liquid in the reservoir 110 and prevent transfer back to the main grill surface 105. FIG. 6A-6C depict an embodiment of the grill 100 with three potential lids 139. The lid 139 may be configured to cover both the grill surface 105 and the reservoir 110, just the grill surface 105 or just the reservoir 110.

Disclosed embodiments relate to a grill 100 with an integrated liquid reservoir 110. The grill 100 includes a main grill surface 105, a reservoir 110 and a divider separating the grill surface 105 from the reservoir 110. The divider has a steeply sloped first side 130 adjacent to the reservoir 110 and a gently sloped second side 120 adjacent to the main grill surface 105. Certain embodiments of the grill 100 may include a retaining wall 103. In some embodiments, the retaining wall 103 surrounds the entire grill 100.

In some embodiments, the main grill surface is substantially smooth, while in other embodiments, the main grill surface contains raised lanes or other texture. Certain embodiments of the grill 100 may include at least one, and preferably two handles 137.

Alternative embodiments of the grill may include an internal heating element 133 configured to heat the grill sufficiently to be used for substantially all cooking methods and techniques. These embodiments include an electrical cord 137 and plug configured to be connected to an electric power supply. These embodiments may also include a lower layer designed to insulate the surface the grill 100 is resting on from the heat of the grill 100 or may include feet 135 to raise the main body of the grill 100 off of the surface the grill 100 is resting on. Both of these features are configured to protect the surface the grill 100 is resting on from the heat generated while using the grill 100.

Embodiments may additionally include a lid 139. The lid 139 may be designed to cover both the main grill surface and the reservoir, only the main grill surface or only the reservoir.

A preferred embodiment of the grill 100 is configured to be heated on an electric stove, gas stove or open flame. The grill 100 may be made substantially of cast iron. In a preferred embodiment the cast iron is enamel coated. The enamel coating may be very colorful.

In an alternative embodiment the grill surface 105 is configured to be replaceable.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed:

1. A grill with an integrated liquid reservoir comprising:
a main grill surface;
a reservoir; and
a divider separating the grill surface and the reservoir, wherein the divider has a steeply sloped first side adjacent to the reservoir and a gently sloped second side adjacent to the main grill surface.

2. The grill of claim 1, further comprising a retaining wall.

3. The grill of claim 2, wherein the retaining wall surrounds the entire grill.

4. The grill of claim 1, wherein the main grill surface is substantially smooth.

5. The grill of claim 1, wherein the main grill surface contains raised lanes.

6. The grill of claim 1, further comprising at least one handle.

7. The grill of claim 1, further comprising an internal electric heating element.

8. The grill of claim 1, wherein the grill is substantially comprised of cast iron.

9. The grill of claim 8, wherein the cast iron is enamel coated.

10. The grill of claim 1, wherein the grill is configured to be heated on an electric stove.

11. The grill of claim 1, wherein the grill is configured to be heated on a gas stove or other open flame.

12. The grill of claim 1, further comprising a lid.

13. The grill of claim 12, wherein the lid is configured to cover the entire grill including the main grill surface and the reservoir.

14. The grill of claim 12, wherein the lid is configured to cover only the reservoir.

15. The grill of claim 12, wherein the lid is configured to cover only the main grill surface.

16. The grill of claim 1, wherein the grill surface is replaceable.
